(19) United States
(12) Patent Application Publication
(10) Pub. No.: US 2015/0187453 A1
(43) Pub. Date: Jul. 2, 2015

(54) ANISOTROPIC CONDUCTIVE FILM AND METHOD FOR MANUFACTURING THE SAME

(71) Applicant: HON HAI PRECISION INDUSTRY CO., LTD., New Taipei (TW)

(72) Inventors: CHANG-CHIN WU, New Taipei (TW); PEI-RONG SHIEH, New Taipei (TW)

(73) Assignee: HON HAI PRECISION INDUSTRY CO., LTD., New Taipei (TW)

(21) Appl. No.: 14/140,534

(22) Filed: Dec. 26, 2013

(51) Int. Cl. H01B 1/16; H01B 13/00

(52) U.S. Cl. CPC H01B 1/16; H01B 13/0026

(57) ABSTRACT

An anisotropic conductive film includes a base board and an insulation adhesive layer coated on a side surface of the base board. The insulation adhesive layer includes a plurality of conductive particles dispersed in the insulation adhesive layer. Each of the plurality of conductive particles includes a spherical base portion, a conductive film formed on the spherical base portion, and an insulation layer with ceramic materials formed on the conductive film. The insulation layer defines a plurality of holes, thus the insulation layer is porous, the insulation layer is capable of being partly exposed from the plurality of holes when the plurality of conductive particles is pressed. A method for manufacturing the anisotropic conductive film is also provided.

### BACKGROUND

1. Technical Field

The present disclosure relates to a conductive film, and particularly to an anisotropic conductive film and method for manufacturing the anisotropic conductive film.

2. Description of Related Art

Anisotropic conductive film (ACF) acts as a conductor across the thickness and an insulator through the length. An anisotropic conductive film is used between various terminals for adhesively bonding and electrically connection. For example, it is used for connection of a driver IC to a liquid crystal panel. In general, an anisotropic conductive film includes a base board and an insulation adhesive layer formed on the base board. A plurality of conductive particles is dispersed in the insulation adhesive layer. The conventional insulation adhesive layer is coated on the base board directly, so that the conductive particles are distributed randomly in the insulation adhesive layer, and the density and the depth of the conductive particles cannot be defined correctly. When the conventional insulation adhesive layer is being pressed, such as cutting, twisting, some conductive particles in the conventional insulation adhesive layer will gather together in a limited field. As a result, the ACF will create a short through the length.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a cross-sectional view of an embodiment of an ACF of the present disclosure.

FIG. 2 is a cross-sectional view of a conductive particle of the ACF in FIG. 1.

FIG. 3 is a cross-sectional view of the conductive particle of the ACF in FIG. 2 which is pressed.

FIG. 4 is a flowchart of an embodiment of a method for manufacturing the ACF in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

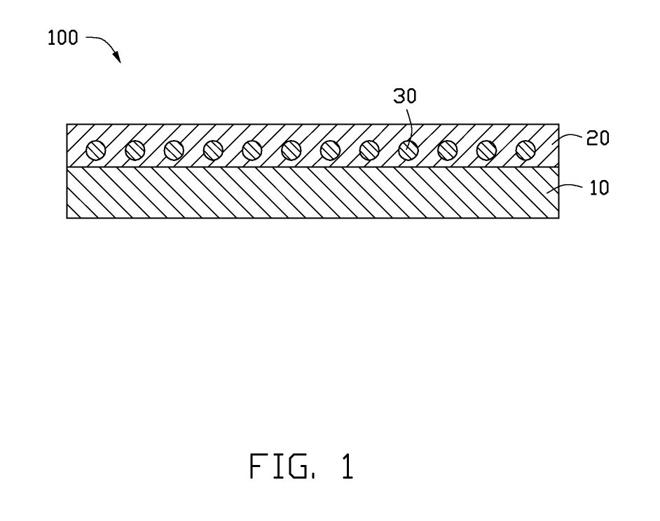

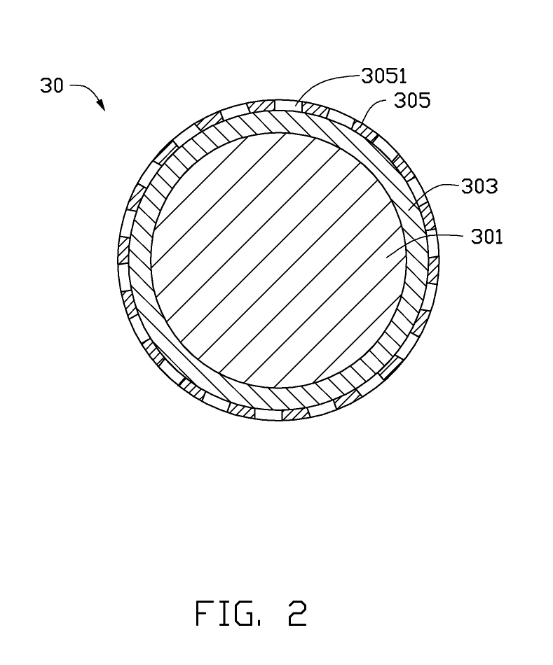

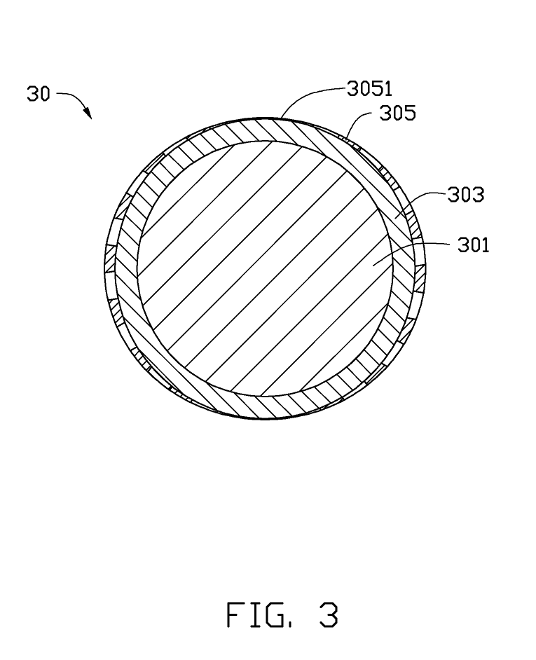

FIGS. 1 to 3 show one embodiment of an anisotropic conductive film (ACF) 100. The ACF 100 includes a base board 10, an insulation adhesive layer 20 coated on a surface of the base board 10, and a plurality of conductive particles 30 dispersed in the insulation adhesive layer 20. Each conductive particles 30 includes a spherical base portion 301, a conductive layer 303, and an insulation layer 305. The conductive layer 303 is formed on the spherical base portion 301 to cover an outer surface of the base portion 301. The insulation layer 305 is formed on the conductive layer 303 to cover an outer surface of the conductive layer 303. That is, the conductive layer 303 is located between the spherical base portion 301 and the insulation layer 305. The insulation layer 305 defines a plurality of holes 3051, such that the insulation layer 305 is porous. When each conductive particle 30 is pressed by an external force, the conductive layer 303 of the conductive particle 30 can be exposed from the holes 3051 of the insulation layer 305.

The base board 10 is configured to be a carrier/holder for the insulation adhesive layer 20. The base board 10 is made of insulating material. In the illustrated embodiment, the base board 10 is made of polyethylene terephthalate (PET).

The insulation adhesive layer 20 is made of thermosetting resin. In the illustrated embodiment, the insulation adhesive layer 20 is made of epoxy resin. The conductive particles 30 are distributed evenly in the insulation adhesive layer 20. In the illustrated embodiment, the conductive particles 30 are distributed with monolayer structure in the insulation adhesive layer 20. The conductive particles 30 on a through direction of the ACF are separated from each other. The “through direction” is defined as a direction parallel to surface of the base board 10. A “across the thickness” is defined as a direction perpendicular to the surface of the base board 10.

The spherical base portion 301 is made of resin, glass, or ceramic, for example. The conductive layer 303 is made of metal, such as nickel (Ni), gold (Au), aluminum (Al) or copper (Cu), for example. The insulation layer 305 is made of ceramic, such as SiO₂, TiO₂ , Si₃N₄ , ZrO₂, for example. In the illustrated embodiment, the spherical base portion 301 is made of resin, the conductive film 303 is made of nickel, and the insulation layer 305 is made of SiO₂. The volume of the insulation layer 305 is in a range from about 0.1 to about 70 percent of the spherical base portion 301. When the conductive particle 30 is pressed by an external force, the insulation layer 305 and the spherical base portion 301 is deformed, and thereby the conductive layer 303 partially protrudes from the holes 3051 of the insulation layer 305.

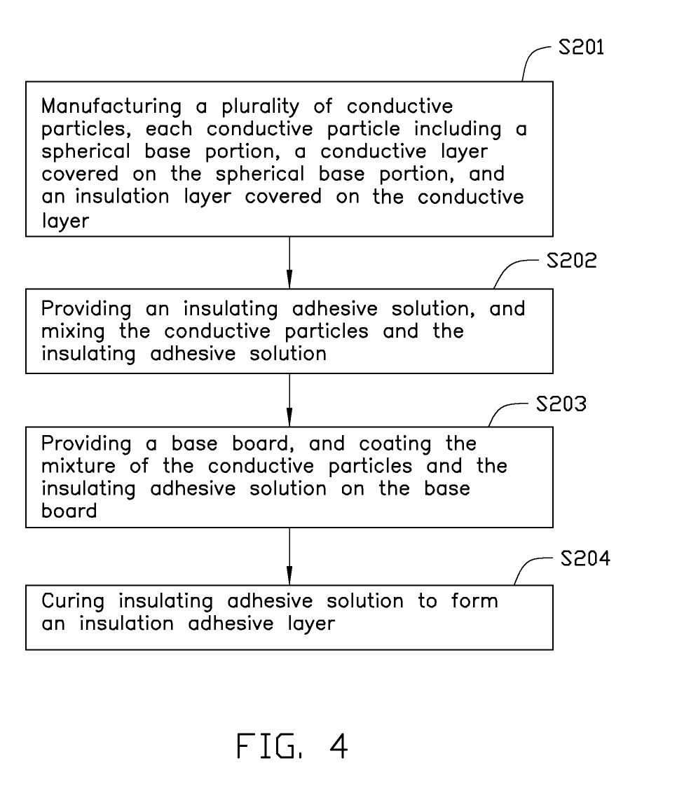

FIG. 4 shows an embodiment of a method for manufacturing the ACF is as follows.

In step S201, a plurality of conductive particles 30 are manufactured. Each conductive particle 30 includes a spherical base portion 301, a conductive layer 303 covered on the spherical base portion 301, and an porous insulation layer 305 covering the conductive layer 303. In the illustrated embodiment, a method for manufacturing the conductive particles 30 is illustrated as follows.

First, a conductive layer 303 is formed on a spherical base portion 301 to cover an outer surface of the spherical base portion 301. The spherical base portion 301 is made of resin. The spherical base portion 301 is made of metal, such as Ni, Au, Al and Cu. The conductive layer 303 is made by a physical process, such as a coating method, or a chemical reduction method. In the illustrated embodiment, the conductive layer 303 is a metal layer made by a chemical reduction method. In the chemical reduction method, the base board 301 is dissolved in a solution containing 0.1 mol/L of HAuCl₄ and 0.03 mol/L of sodium citrate at a temperature in a range from about 110° C. to about 130° C. for about 30 minutes, thus a gold layer with a thickness in a range from about 20 μm to about 40 μm is formed on the outer surface of the base board 301. Therefore, the conductive layer 303 is formed on the spherical base portion 301, and a thickness of the conductive layer 303 is about 20 μm to about 40 μm.

Second, a porous insulation layer 305 is formed on the conductive layer 303 to cover the outer surface of the conductive layer 303. Therefore, a conductive particle 30 is obtained. The insulation layer 305 can be made of ceramic materials, such as SiO2, TiO2 , Si3N4 and ZrO2. In the illustrated embodiment, a porous ceramic layer is covering the conductive layer 303 by a template method coupled with an inorganic synthesis method, such as sol-gel method, co-precipitation method or hydrothermal method. The template method is coupled with the inorganic synthesis method and not limited to those above-motioned methods. Take the sol-gel method as example, a method of covering the insulation layer 305 on the conductive layer 303 is as follows. First, about 2 wt % to about 5 wt % PEGS-PPO70PEO5 is dissolved in isopropyl alcohol. The PEGS-PPO70PEO5 is used as a soft template in a layered arrangement. Second, 15 wt % tetraethylorthosilicate (TEOS) is further added into the isopropyl alcohol, and are evenly mixed for an hour. Third, 1 mol/L of HNO₃ is added into the mixture, to remove the soft template, thereby forming the porous insulation layer 305. A ratio of the volume of the insulation layer 305 relative to the volume of the spherical base portion 301 is about 0.2%-70%.

In step S202, an insulating adhesive solution is provided, and then the conductive particles 30 and the insulating adhesive solution are evenly mixed. In the illustrated embodiment, the insulating adhesive solution is epoxy resin solution.

In step S203, a base board 10 is provided, and the mixture of the conductive particles 30 and the insulating adhesive solution are coated on the base board 10. In the illustrated embodiment, the base board 10 is made of PET. The conductive particles 30 are coated on the base board 10 evenly with a monolayer structure.

In step S204, an insulation adhesive layer 20 is formed by curing the insulating adhesive solution, thereby the ACF 100 is formed. In the illustrated embodiment, the epoxy resin is a thermosetting resin. The epoxy resin is cured by the thermosetting method.

In use, upper and lower surfaces of the ACF would be pressed by the liquid crystal panel and the driver IC., the spherical base portion 301 is deformed and the conductive layer 303 is exposed from the holes 3051. As a result, across the thickness of the ACF is conductive. At the same time, the conductive layer 303 of the conductive particles 30 is covered by the insulation layer 305, the conductive particles 30 on the through direction of the ACF become nonconductive preventing a short.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An anisotropic conductive film (ACF), comprising:
a base board;
an insulation adhesive layer coated on a surface of the base board; and
a plurality of conductive particles dispersed in the insulation adhesive layer, each conductive particle comprising a spherical base portion, a conductive layer formed on the spherical base portion, and an insulation layer formed on the conductive layer;
wherein the insulation layer defines a plurality of holes, thus the insulation layer is porous, the insulation layer is capable of partly exposing from the plurality of holes when the plurality of conductive particles being pressed.

2. The ACF as claimed in claim 1, wherein the insulation layer is made of ceramic materials.

3. The ACF as claimed in claim 1, wherein, the insulation layer is made of SiO2, or TiO2, or Si3N4 or ZrO2.

4. The ACF as claimed in claim 1, wherein a volume ratio of the insulation layer to the spherical base portion is in a range from about 0.1% to about 70%.

5. The ACF as claimed in claim 1, wherein the conductive layer covers an outer surface of the spherical base portion, the insulation layer covers an outer surface of the conductive layer.

6. The ACF as claimed in claim 1, wherein the base board is made of polyethylene terephthalate, the insulation adhesive layer is made of thermosetting resin.

7. The ACF as claimed in claim 1, wherein the plurality of conductive particles is distributed with monolayer structure in the insulation adhesive layer.

8. The ACF as claimed in claim 1, wherein the conductive layer is made of metal, the spherical base portion is made of resin.

9. The ACF as claimed in claim 1, wherein a thickness of the conductive layer is about 20 μm to about 40 μm.

10. A method of manufacturing an anisotropic conductive film (ACF), comprising:
forming a plurality of conductive particles, each conductive particle comprising a spherical base portion, a conductive layer formed on the spherical base portion, and an insulation layer of porous formed on the conductive layer;
providing an insulating adhesive solution and mixing the conductive particles and the insulating adhesive solution;
providing a base board, and coating the insulating adhesive solution mixing the conductive particles on the base board; and
curing the insulating adhesive solution to form the ACF.

11. The method of manufacturing an ACF as recited in claim 10, wherein the insulation layer is made of ceramic materials.

12. The method of manufacturing an ACF as recited in claim 10, wherein a volume ratio of the insulation layer to the spherical base portion is in a range from about 0.1% to about 70%.

13. The method of manufacturing an ACF as recited in claim 10, wherein the insulation layer defines a plurality of holes, thus the insulation layer is porous.

14. The method of manufacturing an ACF as recited in claim 10, wherein the insulation layer in made by template method coupled with sol-gel method, or template method coupled with co-precipitation, or template method coupled with hydrothermal.

15. The method of manufacturing an ACF as recited in claim 11, wherein the template method coupled with sol-gel method to form the insulation layer comprises: dissolving about 2% to about 5% PEGS-PPO70PEO5 in isopropyl alcohol; adding 15 wt % tetraethylorthosilicate (TEOS) in the isopropyl alcohol, and mixing for an hour; adding 1 mol/L of HNO3 in the mixture.

16. The method of manufacturing an ACF as recited in claim 10, wherein the conductive layer is made by coating method.
